(19) United States
(12) Patent Application Publication
(10) Pub. No.: US 2013/0334452 A1
(43) Pub. Date: Dec. 19, 2013

(54) Dosage Valve and Relative Method

(71) Applicant: Emanuele Morselli, Cavezzo (IT)

(72) Inventor: Emanuele Morselli, Cavezzo (IT)

(73) Assignee: CPS Color Equipment Spa Con nico Socio, San Felice Sul Panaro (IT)

(21) Appl. No.: 13/991,887

(22) PCT Filed: Dec. 5, 2011
(86) PCT No.: PCT/IB11/02941

§ 371 Date: Sep. 9, 2013

(30) Foreign Application Priority Data
Dec. 6, 2010 (IT) UD2010A000224

(51) Int. Cl. F16K 15/14

(52) U.S. Cl. CPC F16K 15/14
USPC 251/331

(57) ABSTRACT

A dosage valve for a fluid product, for example a colorant, comprising an at least partly elastic or elastomer element, having at least a cut in the central part so as to define at least two closed/open cooperating lips, which comprises a sensor element associated with the at least partly elastic element in order to detect at least a closed or open condition of the lips.

### CROSS-REFERENCE TO RELATED APPLICATIONS

This application is a U.S. national filing claiming priority under 35 U.S.C. §119(a)-(d) to International Application No. PCT/IB2011/002941, filed Dec. 5, 2011, published in the English language, the entire disclosure of which is incorporated herein by reference.

### BACKGROUND OF THE INVENTION

1. Field of the Invention

The present invention concerns a dosage valve of the membrane type, able to be used in a machine for dispensing fluid products.

In particular, the dosage valve is advantageously applied in machines for dispensing colorants, inks, paints or similar products, but it cannot be excluded that it may also be applied for other types of liquid products and fluids, such as medicines or others.

The dosage valve according to the present invention allows to deliver a defined quantity of the above products with extreme precision, also reducing the risks and frequency of blockages and hence maintenance, and also the influence due to emulsified air bubbles in the colorant or other fluid substance dispensed.

The present invention also concerns the method connected to the dosage valve and a dispensing machine adopting the dosage valve.

2. Description of Related Art

In the field of dispensing machines for fluids such as colorants, inks, paints or similar products, it is known to use dosage valves associated with gear pumps, piston pumps, bellows pumps or others. The dosage valves may be disposed either at one end of the delivery pipe, for example near the dispensing nozzle for introducing the liquids into one or more containers, or in any other position in the dosage circuit.

The dosage valve is disposed substantially in a central position with respect to a hollow tubular body and has an open position for the dosed delivery of the colorant, and a closed position to stop delivery.

Dosage valves are known, made of elastomer material, which have a transit compartment defined by knife-like edges facing each other and in contact when the dosage valve is closed, and detached when the dosage valve is open.

Among these valves made of elastomer material, there are those known with a discoid or ring-shaped membrane, those of the dome type, the so-called “duckbill” valves, an example of which is shown in US 2003/116197 A1, valves known as “umbrella” valves, of the flanged type, with a sleeve and so on.

One disadvantage of known dosage valves of the elastomer type is that the movement into the open position does not always and constantly occur as desired. Furthermore, the presence of possible air bubbles in the fluid substance passing through is not always detected. One or more air bubbles present, for example, in a colorant prevents a desired and precise delivery, and causes inaccuracies in the mixture and hence in the final color.

It should be considered that applications in machines for dosing colorants require systems able to cause the opening of the valve both with doses of volumes of liquid in the range of thousandths of a cubic centimeter, and also volumes in the range of thousands of centimeters in flow rates from 0.5 cubic centimeters a second to 20 cubic centimeters a second, obtaining optimum performance in repeatability and accuracy.

Also the presence of solid particles in the colorants can modify the behavior of the dosage valve, which solid particles remain trapped between the knife-like edges and compromise the seal of the valve itself.

A further disadvantage of known dosage valves is that, in order to guarantee the hermetic seal and to contrast the pressure of the colorant or the pressure of the head alone, the contact pressure normally exerted by the knife-like edge on the elastomer ring membrane is about 10 kg/cm², in combination with the possible presence of hard or solid particles in the fluid. This causes an initial and permanent deformation of the packing, which compromises its sealing function.

One purpose of the present invention is to achieve a dosage valve for fluid products, for example applicable in a dispensing machine for colorants, inks, paints or similar products, which allows to deliver any type of colorant, possibly contaminated, with great accuracy and repeatability and which needs no or minimal maintenance operations.

Another purpose of the present invention is to achieve a dosage valve for fluid products which is constantly controllable, without needing to open the machine to access the dosage valve itself.

Another purpose is to obtain a dosage valve that allows not to distort the dosage, even in the presence of air bubbles in the colorant or any other fluid product to be delivered.

The Applicant has devised, tested and embodied the present invention to overcome the shortcomings of the state of the art and to obtain these and other purposes and advantages.

### BRIEF SUMMARY OF THE INVENTION

The present invention is set forth and characterized in the independent claims, while the dependent claims describe other characteristics of the invention or variants to the main inventive idea.

The dosage valve according to the present invention comprises an elastic or elastomer element of the membrane type, associated with a delivery pipe of the fluid products and cooperating with a valve body having an inlet aperture and an opposite outlet aperture for the fluid product.

The elastomer element comprises at least an at least partly convex surface preferably facing toward the inlet aperture, and an opposite surface, at least partly concave, facing toward the outlet aperture of the valve.

The elastomer element is also provided with at least a through notch that connects the convex surface with the concave surface, which through notch defines two opposite edges or lips configured to selectively obstruct the delivery, when the pressure of the fluid product acting on the convex surface is below a predetermined threshold.

According to one feature of the present invention, the membrane type elastomer element is configured to open only due to the pressure exerted by the fluid, with a threshold value of the pressure in the circuit of around 0.2 bar, and then closes again when the pressure is lower, without using any actuators or other type of drive device whatsoever.

The two edges of the through notch are mobile, when the pressure of the fluid product acting on the convex surface exceeds the threshold value, into at least a second position in which they are partly separated to define a delivery aperture, or transit compartment, of the fluid product toward the outlet aperture.

Thanks to this configuration, the dosage valve according to the present invention allows to obtain a substantially automatic and extremely precise opening function, as a function of the pressure of the fluid product acting on the convex surface.

According to a variant of the present invention, the through notch on the elastomer element is generated so as to define at least three, four or more edges.

According to the present invention, the dosage valve has at least a sensor element associated with at least one edge, the sensor element detecting the open/closed position of the edge.

In particular, the sensor element detects the position of the at least one edge with respect to an inactive condition with zero delivery, so that it can signal an open valve condition and also the entity of opening of the valve, and a closed valve condition.

According to one embodiment of the present invention, the sensor element is made in a single piece with the edge and drowned inside the edge.

In a preferred solution of the present invention, the sensor element has at least one part integrated and drowned in the elastomer membrane, having a thickness in the range of 0.1-0.2 mm. The thickness of the elastomer material, at least in the zone where the sensor element is drowned, is in the range of a millimeter.

In another preferred solution, the sensor element is of the type able to detect a flexion of at least one edge of the dosage valve by means of a potentiometric detection. The sensor element has at least a part that extends into the body of the membrane into close proximity with the position of the opening edges, and in any case into a zone where the movement of the edges is particularly perceived.

In an applicative solution, the potentiometric sensor consists of a substrate treated with a conductive paint that changes its conductivity at the moment it is flexed, even with extremely limited flexion values.

The sensor element is also associated with an electronic acquisition system able to determine, with extremely high resolution, micrometric movements of the membrane.

Thanks to the combination of the proximity of the sensor element to the position of the opening edges, to the extremely limited thickness of the sensor element due to the part drowned in the body of the membrane, and to the detection characteristics of the variation in conductivity, the sensor element according to the present invention is able to guarantee an extremely precise and accurate detection even when there is an extremely limited flexion corresponding to the dosage of an extremely limited quantity of fluid product.

According to another variant, the sensor element is co-molded with the material of the elastomer membrane that defines the opening/closing element of the dosage valve.

It is a characteristic of the present invention, as stated, to provide that the sensor element has the sensitive part disposed as close as possible to the zone subjected to greatest flexion, or deformation in general, in its passage from the open to the closed position, so that the sensitivity and speed of detection is optimized.

Another variant provides that two or more of the sensors are integrated into a single one alone.

Another evolution of the present invention is to provide the sensor element consisting of a bar made of insulating material with high chemical-physical performance, extremely thin and elastic, on which the metal electric conductors are deposited, and which carries at its head the at least one sensitive element drowned or incorporated in the material of the membrane.

By means of the electric conductors the value of electric conductivity indicating the opened/closed state of the valve can be found, and transmitted to a control and command unit that governs the delivery means of the fluid substance.

### BRIEF DESCRIPTION OF THE SEVERAL VIEWS OF THE DRAWINGS

FIG. 1 is a front view of a dosage valve according to the present invention with two facing lips;

FIG. 2 is the section from A to A of the dosage valve in FIG. 1;

FIGS. 3 and 4 show respectively a side view and a perspective view of the sensor element used in the valve in FIG. 1; and

FIG. 5 shows a block diagram of a control system that uses the valve in FIG. 1.

### DETAILED DESCRIPTION OF THE INVENTION

In the following description, particular reference will be made to the application of an elastomer dosage valve 10 of the membrane type to a machine for dispensing colorant, paints or similar fluid products, although this application must not be considered restrictive of the field of the present invention.

The dosage valve 10 is at least partly made of elastomer material and has a membrane element 11 with a central part 12 which, in this case, has a flexion zone 13.

The valve 10 has limited sizes, in this case a diameter “D” comprised between about 12 and about 20 mm, advantageously between about 14 and about 17 mm, and a maximum bulk in height “H” in the range of about 5 mm.

In the central part 12, in this case, there is a cut or notch 24 that defines two lips 14 that create two opposite edges. The cut has a length comprised between about 5 and 8 mm, advantageously comprised between 6 and 7 mm.

Due to the structure of the central part 12, the lips 14 are normally close together so as to create a sealed closure; only when the minimum pressure threshold is reached in the direction of flow, determined by a colorant to be delivered, do they become detached, generating a compartment through which the colorant passes. The valve 10 according to the present invention has a pressure threshold of about 0.2 bar, and when this is exceeded the lips 14 open to allow the fluid product to pass in the direction of delivery.

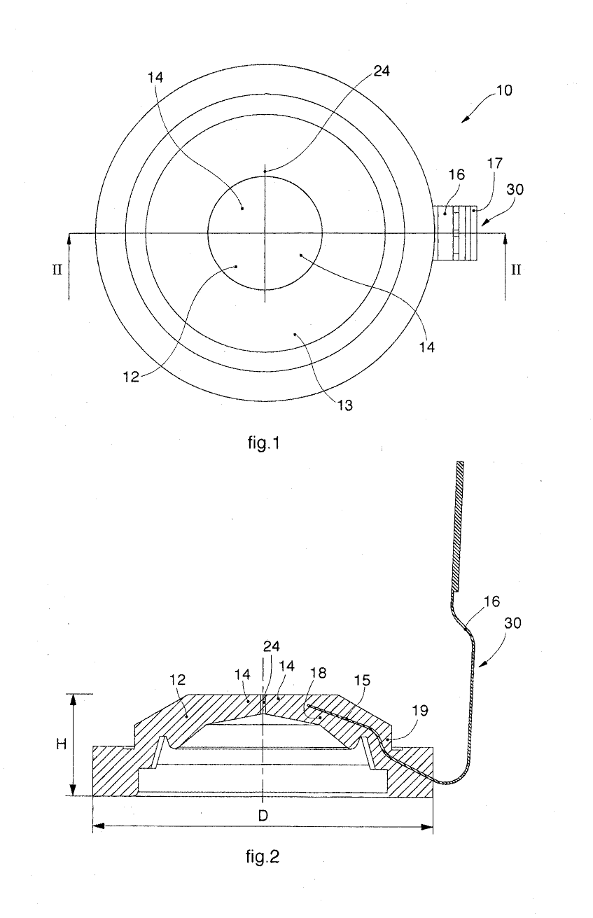

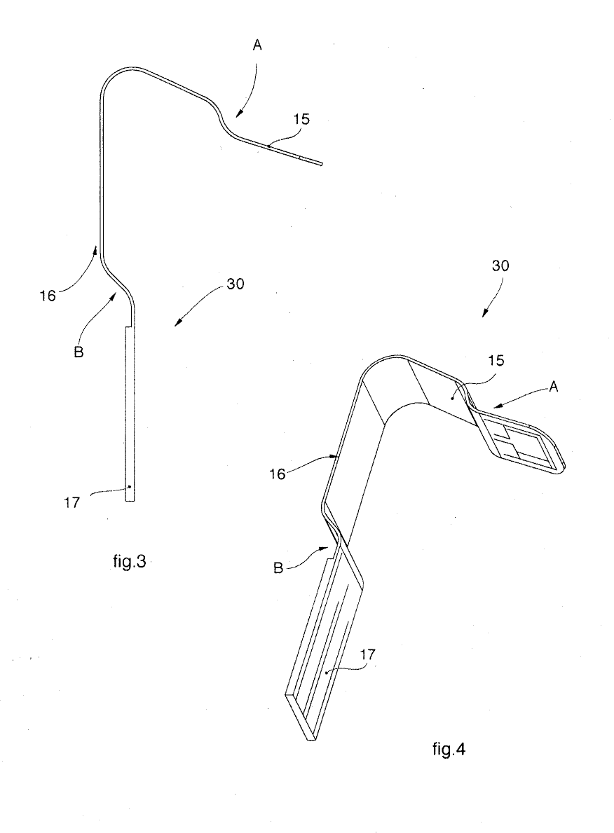

As can be seen in FIG. 2, a sensor element 30 is made in a single piece with the membrane element 11. In particular, the sensor element 30 consists of a support bar 16 having a sensitive element 15 at the ends. The conformation and position of the sensitive element 15 in this case allows to control two zones of the membrane 11, precisely a first zone 18, which communicates the closed or open condition of the lips 14, and a second zone 19 that communicates the presence of flexion in the direction of flow, detecting the entity of the depression generated by the pressure, and hence the entity of the opening of the lip.

The sensitive element 15 of the sensor element 30 in this case has characteristics of electric conductivity, and therefore any deformation of one of its parts caused by the flexion/deformation of the elastomer material of the membrane element 11 causes a variation in the electric conductivity whose value in ohms is directly correlated to the entity of the aperture of the cut 24 between the lips 14.

In one embodiment of the present invention, the bar 16 is made of plastic material treated with a conductive paint that changes its conductivity when the bar 16, in particular the sensitive element 15 drowned in the membrane element, is flexed due to the opening of the lips 14 due to the pressure of the fluid.

In this case, the sensor element 30 has a thickness of about 0.1 mm in its part corresponding to the sensitive element 15, which is drowned in a thickness of about 1 mm of the zones 18 and 19 of the membrane element.

In correspondence with its end part outside the membrane element, there is a stiffening and reinforcement zone 17.

In correspondence with the second zone 19 the sensitive element 15 may cooperate, in a variant, not shown, with a second sensor element in order to generate an opening/closing signal of the valve.

The bar 16 has a double flexion conformation (respectively zone A and zone B—FIGS. 3 and 4) which accentuates the sensitivity to deformation through flexion.

Thanks to this overall conformation, the sensor element 30 is able to determine the opening of the lips 14 both with doses of liquids in the order of thousandths of a cubic centimeter, and also with volumes in the order of thousands of cubic centimeters in the field of flow rates from 0.5 cubic centimeters a second to 20 cubic centimeters a second, with excellent performance in repeatability and accuracy.

An extremely flexible printed circuit is made on the bar 16, by means of which the signal is suitably transferred to processing means.

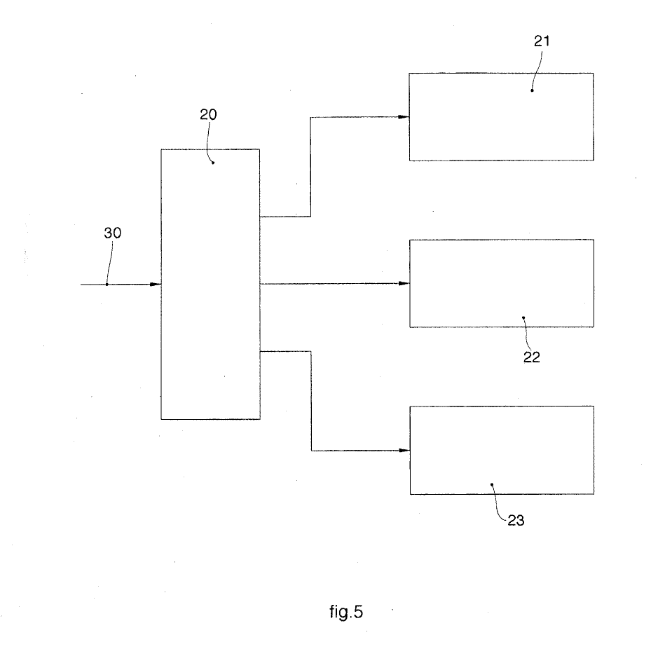

For example, as shown schematically in FIG. 5, the sensor element 30 is connected to processing means 20 which are able to evaluate the presence or absence of the signal arriving from the first 18 and/or the second 19 flexion zone.

Depending on the type of variation in conductivity that is determined by the deformation of the edges, the processing means 20 govern delivery means 21 for the fluid product and/or start/stop means 22 and machine control means 23.

The signal arriving from the processing means 20 also serves to control the state of the membrane and its condition.

Depending on the signal arriving, this control may authorize or not the delivery means 21, it may authorize or not the start/stop means 22, or it can indicate the need for a maintenance intervention or replacement of the dosage valve 10.

It is clear that modifications and variants may be made to the present invention, all of which shall come within the field of protection defined by the attached claims.

1. A dosage valve for a fluid product, for example a colorant, comprising an at least partly elastic or elastomer element, having at least a cut in the central part so as to define at least two closed/open cooperating lips, and comprising a sensor element associated with said at least partly elastic element in order to detect at least a closed or open condition of said lips, wherein said open condition is determined by the pressure exerted by said fluid product, wherein said sensor element has at least a sensitive element drowned inside the elastic or elastomer element, able to detect a flexion of at least one lip of the valve by means of a variation in its conductivity at the moment when said lip is flexed upon opening, wherein said sensitive element of the sensor element is associated to two zones of the elastic or elastomer element, respectively a first zone which communicates the closed or open condition of the lips and a second zone that communicates the presence of flexion in the direction of flow of the fluid product.

2. The dosage valve as in claim 1, wherein said drowned sensitive part or element of the sensor element has a thickness in the range of 0.1-0.2 millimeters.

3. The dosage valve as in claim 1, wherein said sensor element comprises a bar made of plastic material coated with a conductive paint.

4. The dosage valve as in claim 3, wherein said bar has a conformation comprising two flexion zones to accentuate the sensitivity in detecting flexion.

5. The dosage valve as in claim 1, wherein the part of the elastic or elastomer element where the sensitive element of the sensor element is drowned has a thickness in the range of 1 millimeter.

6. The dosage valve as in claim 1, wherein the sensor element is co-molded with the material of the elastic or elastomer element.

7. The dosage valve as in claim 1, wherein the sensor element, in correspondence with its end part outside the elastic or elastomer element, has a stiffened and reinforced zone.

8. The dosage valve as in claim 3, wherein said sensor element is associated with processing means to detect information from said sensor element on the open/closed state of said lips.

9. A method for dosing a fluid product by means of a dosage valve wherein the dosage valve comprising an at least partly elastic or elastomer element, having at least a cut or notch in a central part thereof so as to define at least two closed/open cooperating lips, and comprising a sensor element associated with said at least partly elastic or elastomer element in order to detect at least a closed or open condition of said lips, wherein said open condition is determined by the pressure exerted by said fluid product, wherein said sensor element has at least a sensitive element drowned inside the elastic or elastomer element, able to detect a flexion of at least one of said lips by means of a variation in its conductivity at the moment when said lip is flexed upon opening and, wherein, by controlling by means of the sensor element at least the position of said lips, the delivery and dosing means of the fluid product are controlled and commanded.

10. The method as in claim 9, wherein, by controlling by means of the sensor element at least the position of said lips the conditions of the dosage valve are determined and the interventions and the type of interventions are defined.

11. The method as in claim 9, wherein, by controlling by means of a sensor element at least the state of the cental part of the elastic or elastomer element, the presence of absence of a pressure in the direction of flow is defined.

12. A dosing machine for a fluid product, for example a colorant, wherein the dosing machine has a dosage valve as in claim 1.

13. A dosing machine for dosing a fluid product, for example a colorant, wherein the dosing machine has a dosage valve as in the method of claim 9.

14. The dosage valve as in claim 2, wherein the sensor element, in correspondence with its end part outside the elastic or elastomer element, has a stiffened and reinforced zone.
